(19) United States
(12) Patent Application Publication
(10) Pub. No.: US 2012/0326604 A1
(43) Pub. Date: Dec. 27, 2012

(54) PLASMA DISPLAY DEVICE

(75) Inventors: Kenji Kiriyama, Hyogo (JP); Masayuki Kimura, Osaka (JP); Yoshito Tanaka, Kyoto (JP); Koichi Matsumoto, Osaka (JP)

(73) Assignee: Panasonic Corporation, Osaka (JP)

(21) Appl. No.: 13/203,088

(22) PCT Filed: Jan. 28, 2011
(86) PCT No.: PCT/JP2011/000467

§ 371 Date: Aug. 24, 2011

(30) Foreign Application Priority Data
Feb. 4, 2010 (JP) 2010-022948

(51) Int. Cl. H01J 17/49

(52) U.S. Cl. 313/582

(57) ABSTRACT

A plasma display panel has a sealed part where peripheral portions of a front plate and a rear plate are sealed to each other with a sealing member. The sealed part includes bead which regulates any gap formed between the peripheral portions of the front plate and the rear plate. A dielectric layer is formed as far as location of the bead but an insulator layer is formed short of the location of the bead in the sealed part on the side of a direction where display electrodes extend. The insulator layer is formed as far as the location of the bead but the dielectric layer is formed short of the location of the bead in the sealed part on the side of a direction where data electrodes extend. The bead has a diameter larger than a thickness of the dielectric layer and a height of barrier ribs summed with each other and at most twice as large as the thickness of the dielectric layer and the height of the barrier ribs summed with each other.

THIS APPLICATION IS A U.S. NATIONAL PHASE APPLICATION OF PCT INTERNATIONAL APPLICATION No. PCT/JP2011/000467.

### TECHNICAL FIELD

The technology disclosed herein relates to a plasma display device equipped with a display device.

### BACKGROUND ART

In a plasma display device wherein a plasma display panel (hereinafter, called PDP) is used as a display device, the PDP is held on the side of a front face of a chassis member made of metal such as aluminum. The plasma display device further includes a drive circuit substrate constituting a drive circuit configured to generate a drive voltage for light emission of the PDP (for example, see Patent Document 1).

The PDP has a front plate and a rear plate. The front plate includes a glass substrate, display electrodes formed on a main surface of the glass substrate, a dielectric layer covering the display electrodes to function as a capacitor, and a protective layer made of magnesium oxide (MgO) and formed on the dielectric layer. Meanwhile, the rear plate includes a glass substrate, data electrodes formed on a main surface of the glass substrate, an insulator layer covering the data electrodes, barrier ribs formed on the insulator layer, and phosphor layers respectively formed between the barrier ribs to emit red, green, and blue light.

### PRIOR ART DOCUMENT

### Patent Document

Patent Document 1: Unexamined Japanese Patent Publication No. 2003-131580

### DISCLOSURE OF THE INVENTION

A plasma display device includes a PDP having a front plate and a rear plate disposed facing the front plate. The PDP has a sealed part where peripheral portions of the front plate and the rear plate are sealed to each other with a sealing member. The front plate includes display electrodes and a dielectric layer covering the display electrodes. The rear plate includes electrodes, an insulator layer covering the electrodes, and barrier ribs formed on the insulator layer. The sealed part includes a spherical member which regulates a gap generated between the peripheral portions of the front plate and the rear plate. In the sealed part on the side of a direction where the display electrodes extend, the dielectric layer is formed as far as location of the spherical member, whereas the insulator layer is formed short of the location of the spherical member. In the sealed part on the side of a direction where the electrodes extend, the insulator layer is formed as far as the location of the spherical member, whereas the dielectric layer is formed short of the location of the spherical member. The spherical member has a diameter larger than a thickness of the dielectric layer and a height of the barrier ribs summed with each other and at most twice as large as the thickness of the dielectric layer and the height of the barrier ribs summed with each other.

### BRIEF DESCRIPTION OF THE DRAWINGS

FIG. 1 is a perspective view illustrating a structure of a PDP according to an embodiment of the present invention.

FIG. 2 is a sectional view illustrating a structure of discharge cells in the PDP according to the embodiment.

FIG. 3 is an illustration of an electrode array in the PDP.

FIG. 4 is a block circuit diagram of a plasma display device according to the embodiment.

FIG. 5 is a waveform chart of a drive voltage in the plasma display device.

FIG. 6 is a plan view of the PDP according to the embodiment.

FIG. 7 is a sectional view cut along A-A in FIG. 6.

FIG. 8 is a sectional view cut along B-B in FIG. 6.

FIG. 9 is a long-side sectional view of the PDP according to the embodiment.

### PREFERRED EMBODIMENTS FOR CARRYING OUT OF THE INVENTION

### 1. Structure of PDP 100

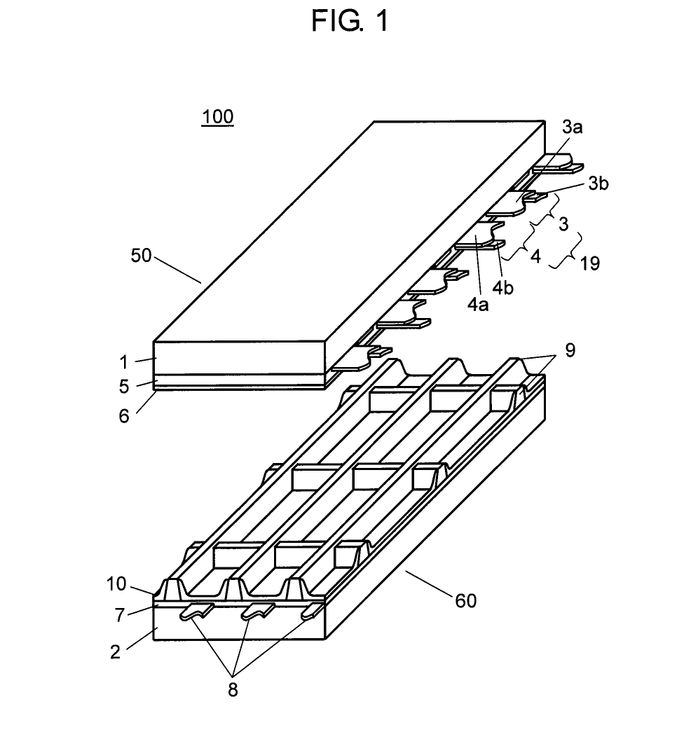

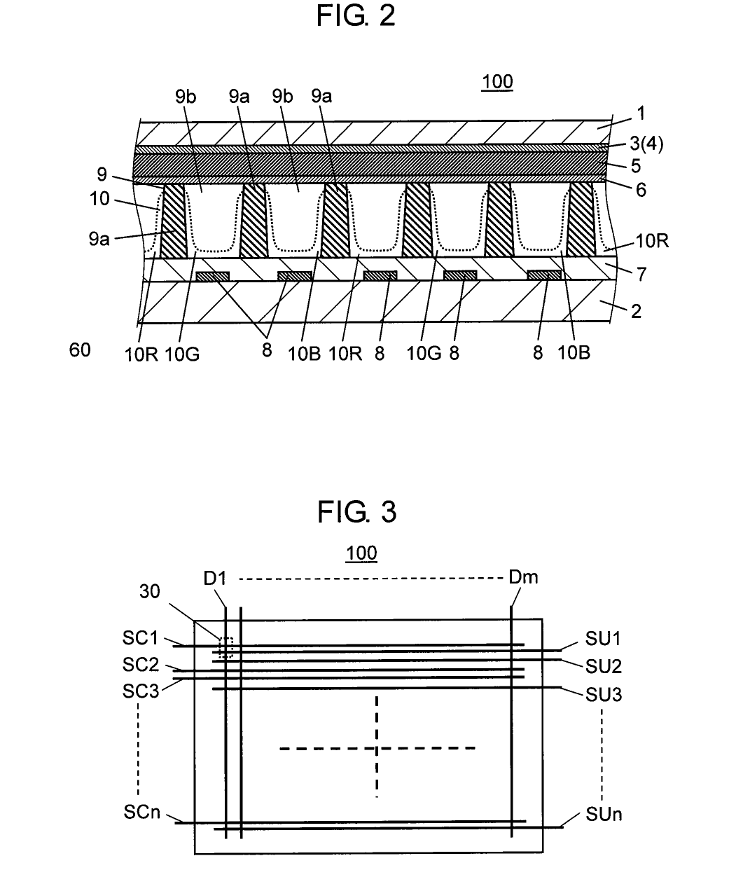

PDP 100 according to an embodiment of the present invention is an alternating current surface discharge PDP. As illustrated in FIGS. 1 and 2, PDP 100, for example, has a structure where front substrate 1 and rear substrate 2 both made of glass are disposed facing each other with a discharge space interposed therebetween. A plurality of scan electrodes 3 and sustain electrodes 4 constituting display electrodes are formed on front substrate 1 so that they are respectively paired with each other in parallel with a discharge gap interposed therebetween. Dielectric layer 5 made of, for example, a glass material is formed so as to cover scan electrodes 3 and sustain electrodes 4. Protective layer 6 made of magnesium oxide (MgO) is formed on dielectric layer 5. Scan electrodes 3 each include transparent electrode 3a made of, for example, indium tin oxide (ITO) and bus electrode 3b made of, for example, silver (Ag) and formed on transparent electrode 3a. Sustain electrodes 4 each include transparent electrode 4a made of, for example, ITO and bus electrode 4b made of, for example, Ag and formed on transparent electrode 4a. Front substrate 1 provided with the structural elements described so far constitutes front plate 50. A pair of scan electrode 3 and sustain electrode 4 constitutes display electrode 19.

A plurality of data electrodes 8 for the application of a drive voltage and insulator layer 7 which covers data electrodes 8 are provided on rear substrate 2. Barrier ribs 9 formed in a lattice-like shape are provided on insulator layer 7. Barrier ribs 9 include longitudinal barrier ribs 9a in parallel with data electrodes 8 and lateral barrier ribs 9b orthogonal to longitudinal barrier ribs 9a. Barrier ribs 9 divide a discharge space formed between front plate 1 and rear plate 2 into discharge cells. A surface of insulator layer 7 and side surfaces of barrier ribs 9 are provided with phosphor layers 10 which respectively emit red light (R), blue light (B), and green light (G). Rear substrate 2 provided with the structural elements described so far constitutes rear plate 60.

Front plate 50 and rear plate 60 are disposed facing each other so that scan electrodes 3 and sustain electrodes 4 intersect with data electrodes 8. A mixed gas containing, for example, neon (Ne) and xenon (Xe) is enclosed as a discharge gas in the discharge space formed between front plate 50 and rear plate 60 under a pressure in the range of 53 kPa (400 Torr) to 80 kPa (600 Torr).

The discharge gas enclosed in the discharge space according to the present embodiment includes Xe by at least 10 vol. % and at most 30 vol. %.

### 2. Structure of Plasma Display Device 200

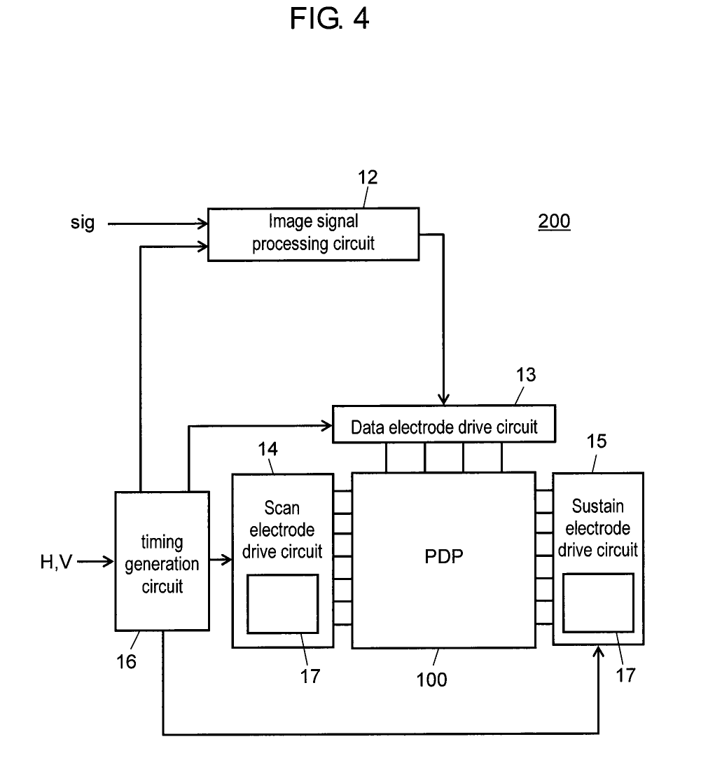

As illustrated in FIGS. 3 and 4, plasma display device 200 includes PDP 100. As illustrated in FIG. 3, PDP 100 has n number of scan electrodes SC1, SC2, SC3, . . . , SCn (scan electrodes 3 illustrated in FIG. 1) respectively extending in row direction, and n number of sustain electrodes SU1, SU2, SU3, . . . , SUn (sustain electrodes 4 illustrated in FIG. 1) similarly extending in row direction. Further, PDP 100 has m number of data electrodes D1, . . . , Dm (data electrodes 8 illustrated in FIG. 1) respectively extending in column direction. Discharge cell 30 is formed at an intersection of a pair of scan electrode SC1 and sustain electrode SU1 with one data electrode D1, and there are m×n discharge cells 30 in the discharge space. The sustain electrodes and the scan electrodes are connected to connection terminals provided in a marginal portion of the front plate on the outer side of an image display region.

As illustrated in FIGS. 3 and 4, plasma display device 200 has data electrode drive circuit 13. Data electrode drive circuit 13 has a plurality of data drivers (not illustrated in the drawings) connected to one ends of data electrodes 8 and including semiconductor devices for applying voltages to data electrodes 8.

As illustrated in FIG. 4, plasma display device 200 has PDP 100, image signal processing circuit 12, data electrode drive circuit 13, scan electrode drive circuit 14, sustain electrode drive circuit 15, timing generation circuit 16, and a power supply circuit (not illustrated in the drawings). Scan electrode drive circuit 14 and sustain electrode drive circuit 15 each have sustain pulse generator 17.

Image signal processing circuit 12 converts image signal sig into image data for each sub field. Data electrode drive circuit 13 converts the image data generated per sub field into signals corresponding to data electrodes D1 to Dm and thereby drives data electrodes D1 to Dm. Timing generation circuit 16 generates various timing signals based on horizontal synchronous signal H and vertical synchronous signal V, and supplies the generated timing signals to the respective drive circuit blocks. Scan electrode drive circuit 14 applies drive voltage waveforms to scan electrodes SC1 to SCn based on the timing signals. Sustain electrode drive circuit 15 applies drive voltage waveforms to sustain electrodes SU1 to SUn based on the timing signals.

Below are described the drive voltage waveforms for driving PDP 100 and an operation for driving PDP 100 referring to FIG. 4.

2-1. Method for Driving Plasma Display Device 200

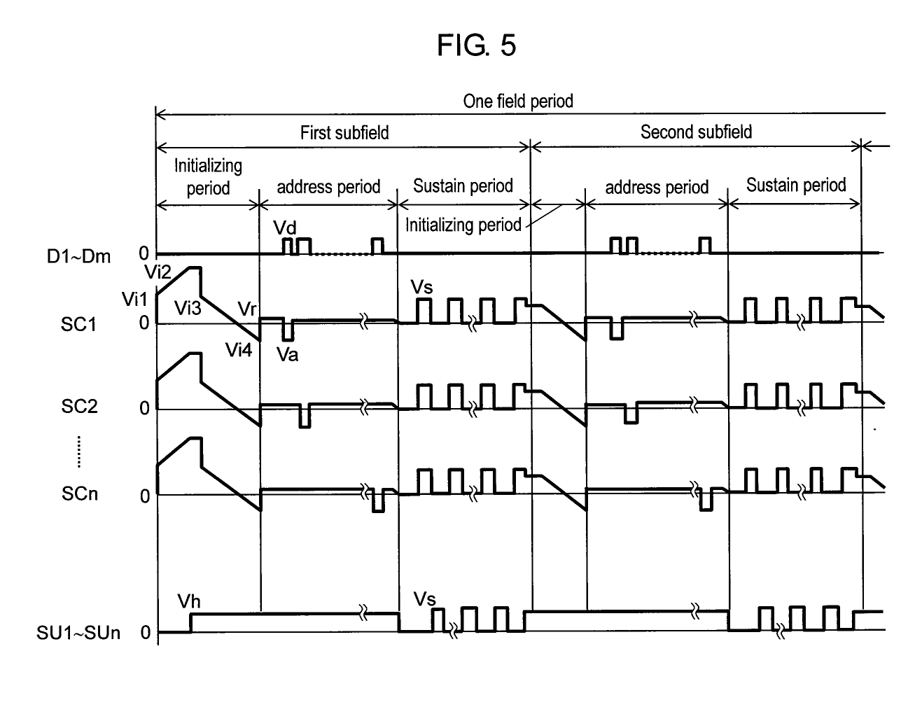

As illustrated in FIG. 5, one field includes a plurality of sub fields in plasma display device 200 according to the present embodiment. Each sub field has an initializing period, an address period, and a sustain period. The initializing period is a period for generating initializing discharge in the discharge cells. The address period, which follows the initializing period, is a period for generating address discharge to select the discharge cell for light emission. The sustain period is a period for making the discharge cell selected in the address period generate sustain discharge.

2-1-1. Initializing Period

During the initializing period of first sub field, data electrodes D1 to Dm and sustain electrodes SU1 to SUn are kept at 0 (V). A ramp voltage moderately elevating from voltage Vi1 (V) equal to or below a discharge start voltage to voltage Vi2 (V) exceeding the discharge start voltage is applied to scan electrodes SC1 to SCn. Then, a first round of very weak initializing discharge is generated in all of the discharge cells. As a result of the initializing discharge, negative wall voltages are stored on scan electrodes SC1 to SCn, and positive wall voltages are stored on sustain electrodes SU1 to SUn and data electrodes D1 to Dm. The wall voltage is a voltage generated by wall charges stored on, for example, protective layer 6 and phosphor layers 10.

After that, sustain electrodes SU1 to SUn are kept at positive voltage Vh (V). A ramp voltage moderately declining from voltage Vi3 (V) to voltage Vi4 (V) is applied to scan electrodes SC1 to SCn. Then, a second round of very weak initializing discharge is generated in all of the discharge cells, and wall voltages between scan electrodes SC1 to SCn and sustain electrodes SU1 to SUn are thereby weakened. The wall voltages on data electrodes D1 to Dm are adjusted to values suitable for an address operation.

[2-1-2. Address Period]

During the address period subsequent to the initializing period, scan electrodes SC1 to SCn are temporarily kept at Vr (V). Negative scan pulse voltage Va (V) is applied to scan electrode SC1 in the first row. Then, positive address pulse voltage Vd (V) is applied to data electrode Dk (k=1 to m) of the discharge cell to be displayed on the first row among data electrodes D1 to Dm. A voltage at the intersection of data electrode Dk with scan electrode SC1 then results in a value obtained by adding the wall voltage on data electrode Dk and the wall voltage on scan electrode SC1 to an external applied voltage (Vd−Va) (V), meaning that the voltage at the intersection of data electrode Dk with scan electrode SC1 exceeds the discharge start voltage. Then, the address discharge is generated between data electrode Dk and scan electrode SC1 and also between sustain electrode SU1 and scan electrode SC1. Then, a positive wall voltage is stored on scan electrode SC1 of the discharge cell where the address discharge was generated, a negative wall voltage is stored on sustain electrode SU1 of the discharge cell where the address discharge was generated, and a negative wall voltage is stored on data electrode Dk of the discharge cell where the address discharge was generated.

The voltages at the intersections of data electrodes D1 to Dm with scan electrode SC1, to which address pulse voltage Vd (V) was not applied, stay below the discharge start voltage. Therefore, the address discharge is not generated between these electrodes. The address operation described so far is sequentially performed to all of the discharge cells up to an nth row. The address period ends when the address operation for the discharge cell on the nth row is completed.

2-1-3. Sustain Period

During the sustain period subsequent to the address period, positive sustain pulse voltage Vs (V) is applied as a first voltage to scan electrodes SC1 to SCn, and a ground potential, that is 0 (V), is applied as a second voltage to sustain electrodes SU1 to SUn. In the discharge cell where the address discharge is generated, a voltage between scan electrode SCi and sustain electrode SUi results in a value obtained by adding the wall voltage on scan electrode SCi and the wall voltage on sustain electrode SUi to sustain pulse voltage Vs (V), which exceeds the discharge start voltage. Then, the sustain discharge is generated between scan electrode SCi and sustain electrode SUi. The sustain discharge generates ultraviolet light, and the generated ultraviolet light excites the phosphor layers, making them emit the light. A negative wall voltage is stored on scan electrode SCi, a positive wall voltage is stored on sustain electrode SUi, and a positive wall voltage is stored on data electrode Dk.

There is no sustain discharge in any of the discharge cells where the address discharge was not generated during the address period. Therefore, the wall voltages when the initializing period ends are retained. Then, the second voltage, that is 0 (V), is applied to scan electrodes SC1 to SCn. The first voltage, that is sustain pulse voltage Vs (V), is applied to sustain electrodes SU1 to SUn. In the discharge cell where the sustain discharge was generated, a voltage between sustain electrode SUi and scan electrode SCi exceeds the discharge start voltage, and the sustain discharge is generated again between sustain electrode SUi and scan electrode SCi. Therefore, a negative wall voltage is stored on sustain electrode SUi, and a positive wall voltage is stored on scan electrode SCi.

Similarly, such a number of sustain pulse voltages Vs (V) that responsive to luminance weights are thus applied to scan electrodes SC1 to SCn and sustain electrodes SU1 to SUn in turn, so that the sustain discharge is continuously generated in the discharge cells where the address discharge was generated during the address period. When the application of a given number of sustain pulse voltages Vs (V) is completed, the sustain operation during the sustain period ends.

2-1-4. Second Sub Field and Fields Thereafter

In and after second sub field, operations similar to those in first sub field are performed during the initializing period, address period, and sustain period. Therefore, detailed description of the operations is omitted. In and after second sub field, a selective initializing operation may be performed, more specifically, the initializing discharge may be selectively generated in only the discharge cells where the sustain discharge was generated in any preceding sub field. The present embodiment performs the all-cell initializing operation in first sub field and the selective initializing operation in other sub fields. The present embodiment may perform the all-cell initializing operation in any sub fields but first sub field, or may perform the all-cell initializing operation intermittently once in every two or three fields.

The operations during the address period and the sustain period are similar to the operations in first sub field, however, the operation during the sustain period is different to the operation in first sub field. To enable such a sustain discharge that can obtain a level of luminance corresponding to image signal sig, the number of the sustain discharge pulses Vs (V) changes. During the sustain period, the electrodes are driven so that a level of luminance per sub field is controlled.

### 3. Production Method of PDP 100

3-1. Production Method of Front Plate 50

Scan electrodes 3 and sustain electrodes 4 are formed on front substrate 1 by photolithography. Scan electrode 3 includes transparent electrode 3a made of, for example, indium tin oxide (ITO) and bus electrode 3b made of, for example, silver (Ag) and formed on transparent electrode 3a. Sustain electrode 4 includes transparent electrode 4a made of, for example, ITO and bus electrode 4b made of, for example, Ag and formed on transparent electrode 4a.

A material used to form bus electrodes 3b and 4b is an electrode paste containing a glass frit for increasing a silver-silver (Ag) binding strength, a photosensitive resin, and a solvent. The electrode paste is spread on front substrate 1 where transparent electrodes 3a and 4a are formed by, for example, screen printing. Then, the solvent in the electrode paste is removed in a baking oven, and the electrodes paste is then exposed to light via a photo mask formed in a predetermined pattern.

Then, the electrode paste is developed so that a bus electrode pattern is formed. Lastly, the bus electrode pattern is fired in a baking oven at a given temperature so that the photosensitive resin in the electrode pattern is removed. Further, the glass frit in the electrode pattern is melted during the firing, and the melted glass frit starts to vitrify again as cooled down to room temperature. As a result of these steps, bus electrodes 3b and 4b are formed. In place of screen printing employed to apply the electrode paste, sputtering or vapor deposition may be employed.

Next, dielectric layer 5 is formed. A material used to form dielectric layer 5 is, for example, a dielectric paste containing a dielectric glass frit, a resin, and a solvent. First, the dielectric paste is spread in a given thickness by die printing on front substrate 1 so as to cover scan electrodes 3 and sustain electrodes 4. Then, the solvent in the dielectric paste is removed in a dry furnace. Lastly, the dielectric paste is fired at a predetermined temperature in a baking oven so that the resin in the dielectric paste is removed. Further, the dielectric glass frit is melted during the firing, and the melted glass frit starts to vitrify again as cooled down to room temperature. As a result of these steps, dielectric layer 5 is formed. In place of die coating employed to apply the dielectric paste, screen printing or spin coating may be employed. Instead of using the dielectric paste, a film used as dielectric layer 5 may be formed by, for example, CVD (Chemical Vapor Deposition).

Then, protective layer 6 is formed on dielectric layer 5.

As a result of the steps described so far, the production of front plate 50 provided with scan electrodes 3, sustain electrodes 4, dielectric layer 5, and protective layer 6 on front substrate 1 is completed.

3-2. Production Method of Rear Plate 60

Data electrodes 8 are formed on rear substrate 2 by photolithography. A material used to form data electrodes 8 is, for example, a data electrode paste containing a glass frit for obtaining a silver (Ag)—Ag binding strength to ensure an electrical conductivity, a photosensitive resin and a solvent. First, the data electrode paste is spread in a given thickness on rear substrate 2 by screen printing, and the solvent in the data electrode paste is removed in a baking oven. Then, the data electrode paste is exposed to light via a photo mask formed in a predetermined pattern. Then, the data electrode paste is developed so that a data electrode pattern is formed. Lastly, the data electrode pattern is fired in a baking oven at a given temperature so that the photosensitive resin in the data electrode pattern is removed. Further, the glass frit in the data electrode pattern is melted during the firing, and the melted glass frit starts to vitrify again as cooled down to room temperature. As a result of these steps, data electrodes 8 are formed. In place of screen printing employed to apply the data electrode paste, sputtering or vapor deposition may be employed.

Then, insulator layer 7 is formed. A material used to form insulator layer 7 is, for example, an insulator paste containing an insulator glass frit, a resin, and a solvent. First, the insulator paste is spread in a given thickness by screen printing on rear substrate 2 having data electrodes 8 formed thereon so as to cover data electrodes 8. Then, the solvent in the insulator paste is removed in a dry furnace. Lastly, the insulator paste is fired at a predetermined temperature in a baking oven so that the resin in the insulator paste is removed. Further, the insulator glass frit is melted during the firing, and the melted glass frit starts to vitrify again as cooled down to room temperature. As a result of these steps, insulator layer 7 is formed. In place of screen printing employed to apply the insulator paste, die coating or spin coating may be employed. Instead of using the insulator paste, a film used as insulator layer 7 may be formed by, for example, CVD (Chemical Vapor Deposition).

Next, barrier ribs 9 are formed by photolithography. A material used to form barrier ribs 9 is, for example, a barrier rib paste containing a filler, a glass frit as a filler binding agent, a photosensitive resin, and a solvent. The barrier rib paste is spread on insulator layer 7 in a given thickness by die coating. Then, the solvent in the barrier rib paste is removed in a dry furnace, and the barrier rib paste is exposed to light via a photo mask formed in a predetermined pattern. The barrier rib paste is then developed so that a barrier rib pattern is formed. Lastly, the barrier rib pattern is fired at a given temperature in a baking oven so that the photosensitive resin in the barrier rib pattern is removed. Further, the glass frit in the barrier rib pattern is melted during the firing, and the melted glass frit starts to vitrify again as cooled down to room temperature. As a result of these steps, barrier ribs 9 are formed. The photolithography may be replaced with, for example, sandblasting.

Next, phosphor layers 10 are formed. A material used to form phosphor layers 10 is, for example, a phosphor paste containing phosphor particles, a binder, and a solvent. The phosphor paste is spread by dispensing in a given thickness on insulator layer 7 between adjacent barrier ribs 9 and side surfaces of barrier ribs 9. Then, the solvent in the phosphor paste is removed in a dry furnace. Lastly, the phosphor paste is fired at a predetermined temperature in a baking oven so that the resin in the phosphor paste is removed. As a result of these steps, phosphor layers 10 are formed. The dispensing may be replaced with, for example, screen printing.

As a result of the steps described so far, the production of rear plate 60 provided with data electrodes 8, insulator layer 7, barrier ribs 9, and phosphor layers 10 on rear substrate 2 is completed.

3-3. Assembling Method of Front Plate 50 and Rear Plate 60

A sealing paste is spread in a peripheral portion of rear plate 60 by dispensing. The sealing paste contains beads 21 illustrated in FIGS. 7 and 8, a low-melting glass material, a binder, a solvent, and the like. The sealing paste thus spread forms a sealing paste layer (not illustrated in the drawings). The solvent in the sealing paste layer is removed in a dry furnace, and the sealing paste layer is then temporarily fired at approximately 350° C. so that the resin component included in the sealing paste layer is removed. Next, front plate 50 and rear plate 60 are disposed facing each other so that display electrodes 19 and data electrodes 8 are orthogonal to each other.

Then, peripheral portions of front plate 50 and rear plate 60 are pressed to each other with, for example, clips. Then, front plate 50 and rear plate 60 thus put together are fired at a given temperature so that the low-melting glass material is melted. As front plate 50 and rear plate 60 are cooled down to room temperature, the melted low-melting glass material starts to vitrify again, and front plate 50 and rear plate 60 are air-tightly sealed to each other. Lastly, the discharge gas containing Ne and Xe is enclosed in the discharge space, and the production of PDP 100 is completed.

### 4. Structure of Sealed Part 20

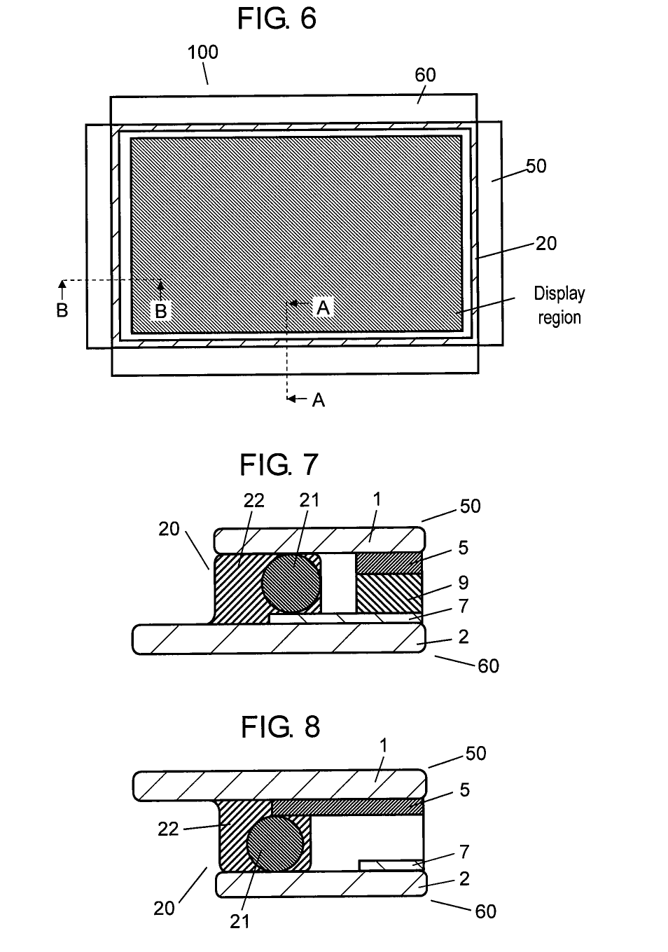

As illustrated in FIG. 6, sealed part 20 is formed in an outer peripheral portion of PDP 100. In PDP 100 according to the present embodiment, long sides of front plate 50 are dimensionally larger than short sides of rear plate 60, and short sides of front plate 50 are dimensionally smaller than short sides of rear plate 60, in other words, short sides of rear plate 60 are dimensionally larger than short sides of front plate 50. Front plate 50 has a plurality of display electrodes 19 arranged in the direction of its long sides so that terminals of display electrodes 19 are situated on rims of its short sides. Rear plate 60 has a plurality of data electrodes 8 arranged in the direction of its short sides so that terminals of data electrodes 8 are situated on rims of its long sides.

Sealed part 20 is formed to connect two long-side rims of front plate 50 and two short-side rims of rear plate 60 to each other. Sealed part 20 is formed on the outer side of a display region of PDP 100.

As illustrated in FIGS. 7 and 8, sealed part 20 includes beads 21 and sealing member 22. Bead 21 is, for example, a spherical member made of a glass material. The “spherical shape” does not necessary indicate a geometrically perfect spherical shape. The “spherical shape” means any shape that can be substantially recognized as a “spherical shape” through a microscopic observation, and the like. A main ingredient of sealing member 22 is a low-melting glass material. The softening point of the glass material used to form bead 21 is preferably higher than the softening point of the low-melting glass material used to form sealing member 22. The melting point of the glass material used to form bead 21 is preferably higher than the melting point of the low-melting glass material used to form sealing member 22. A firing temperature during the sealing process is preferably higher than the melting point of the low-melting glass material used to form sealing member 22 and lower than the melting point of the glass material used to form bead 21. The bead 21 can keep its own original shape after the firing process so that any gap between front plate 50 and rear plate 60 can be thereby regulated. The gap between front plate 50 and rear plate 60 in sealed part 20 is decided based on the dimension of bead 21.

As illustrated in FIG. 7, insulator layer 7 is formed as far as location of beads 21, whereas dielectric layer 5 is formed short of the location of beads 21 in sealed part 20 formed on the rim on the side of a direction where data electrodes 8 extend.

As illustrated in FIG. 8, dielectric layer 5 is formed as far as the location of beads 21, whereas insulator layer 7 is formed short of the location of beads 21 in sealed part 20 formed on the rim on the side of a direction where display electrodes 19 extend.

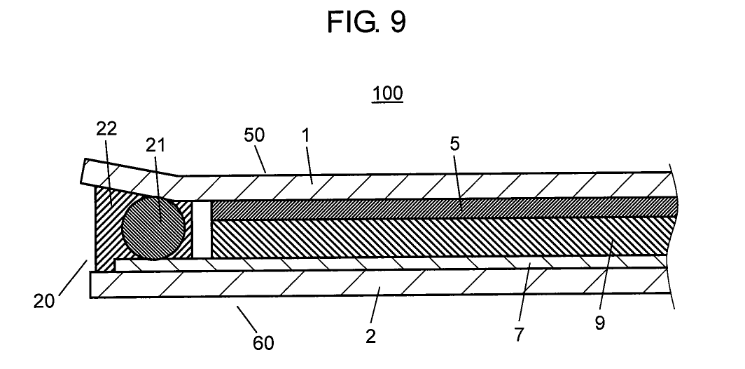

As illustrated in FIG. 9, beads 21 preferably has a diameter larger than a thickness of dielectric layer 5 and a height of barrier ribs 9 summed with each other and at most twice as large as the thickness of dielectric layer 5 and the height of barrier ribs 9 summed with each other.

In FIGS. 7, 8, and 9, a longitudinal reduction scale is larger than a lateral reduction scale to facilitate the description. Therefore, sealed part 20 in a finished product has a width larger than the diameter of beads 21.

### 5. Summary

Plasma display device 200 according to the present embodiment includes PDP 100 having front plate 50 and rear plate 60 disposed facing front plate 50. PDP 100 has sealed part 20 where peripheral portions of front plate 50 and rear plate 60 are sealed to each other with sealing member 22. Front plate 50 includes display electrodes 19 and dielectric layer 5 covering display electrodes 19. Rear plate 60 includes data electrodes 8 used as electrodes, insulator layer 7 covering data electrodes 8, and barrier ribs 9 formed on insulator layer 7. Sealed part 20 includes beads 21 as a spherical member which regulates any gap formed between the peripheral portions of front plate 50 and rear plate 60. In sealed part 20 on the side of a direction where display electrodes 19 extend, dielectric layer 5 is formed as far as location of beads 21, whereas insulator layer 7 is formed short of the location of beads 21. In sealed part 20 on the side of a direction where data electrodes 8 extend, insulator layer 7 is formed as far as the location of beads 21, whereas dielectric layer 5 is formed short of the location of beads 21. Beads 21 has a diameter larger than the sum of the thickness of dielectric layer 5 and the height of barrier ribs 9 and at most twice as large as the sum of the thickness of dielectric layer 5 and the height of barrier ribs 9.

There is dielectric layer 5 or insulator layer 7 where beads 21 of sealed part 20 according to the present embodiment is located. Unless dielectric layer 5 or insulator layer 7 is present where beads 21 are located, front plate 50 has a region where display electrodes 19 are present and a region where front substrate 1 alone is present, and rear plate 60 has a region where data electrodes 8 are present and a region where rear substrate 2 alone is present. The mixture of these regions results in failure to uniformly distribute beads 21 in sealed part 20. According to the present embodiment, dielectric layer 5 or insulator layer 7 is formed in the region of sealed part 20 where beads 21 are provided. In sealed part 20, therefore, display electrodes 19 are coated with dielectric layer 5 and data electrodes 8 are coated with insulator layer 7. The structure according to the present embodiment described so far reduces variability of the region where beads 21 are provided, thereby reducing variability of the gap in sealed part 20 among different plasma display devices.

Due to the production variability of PDP 100, dielectric layer 5, which is not completely flat, has an uneven thickness. Further, barrier ribs 9 also have some variability in height. Therefore, the sum of the thickness of dielectric layer 5 and the height of barrier ribs 9 is not constant in products. According to the present embodiment wherein the diameter of bead 21 is larger than the sum of the thickness of dielectric layer 5 and the height of barrier ribs 9 and at most twice as large as the sum of the thickness of dielectric layer 5 and the height of barrier ribs 9, any gap in sealed part 20 can be constant irrespective of the variable dimensional values.

### 6. Example

Plasma display device 200 was produced. PDP 100 used in produced plasma display device 200 is compliant with the specification of a 42-inch full high vision television. PDP 100 has front plate 50 and rear plate 60 disposed facing front plate 50, and peripheral portions of front plate 50 and rear plate 60 are sealed to each other with a sealing member. Front plate 50 includes a plurality of scan electrodes 3, a plurality of sustain electrodes 4, dielectric layer 5, and protective layer 6. Rear plate 60 includes data electrodes 8, insulator layer 7, barrier ribs 9, and phosphor layers 10. A neon (Ne)—xenon (Xe)-based mixed gas containing xenon (Xe) by 15 vol. % was enclosed in PDP 100 under the internal pressure of 60 kPa. The thickness of dielectric layer 5 had the set value of 30 the height of barrier ribs 9 had the set value of 120 μm, and the thickness of insulator layer 7 had the set value of 10 μm. The diameter of bead 21 was 160 μm. The diameter is an average particle diameter (volume cumulative diameter D50). To measure the average particle diameter, a particle size distribution measuring apparatus of laser diffraction type MT-3300 (supplied by NIKKISO CO., LTD.) was used.

The gap in sealed part 20 on the side of the direction where display electrodes 19 extend was larger than the gap in sealed part 20 on the side of the direction where data electrodes 8 extend.

It was confirmed by the inventors of the present invention that a favorable result could be obtained from PDP 100 wherein the diameter of bead 21 was larger than the sum of the thickness of dielectric layer 5 and the height of barrier ribs 9 and at most twice as large as the sum of the thickness of dielectric layer 5 and the height of barrier ribs 9 on the condition that a distance from the display region to an inner end of sealed part 20 in PDP 100 was 5 mm to 30 mm.

### INDUSTRIAL APPLICABILITY

The technology disclosed in the present embodiment described so far is advantageous for accomplishing a high-quality plasma display device.

### REFERENCE MARKS IN THE DRAWINGS

1 front substrate
2 rear substrate
3 scan electrode
4 sustain electrode
3a, 4a transparent electrode
3b, 4b bus electrode
5 dielectric layer
6 protective layer
7 insulator layer
8 data electrode
9 barrier rib
10 phosphor layer
12 image signal processing circuit
13 data electrode drive circuit
14 scan electrode drive circuit
15 sustain electrode drive circuit
16 timing generation circuit
17 sustain pulse generator
19 display electrode
20 sealed part
21 bead
22 sealing member
30 discharge cell
50 front plate
60 rear plate
100 PDP
200 plasma display device

1. A plasma display device comprising:
a plasma display panel having a front plate and a rear plate disposed facing the front plate, wherein
the plasma display panel has a sealed part where peripheral portions of the front plate and the rear plate are sealed to each other with a sealing member,
the front plate includes display electrodes and a dielectric layer covering the display electrodes,
the rear plate includes electrodes, an insulator layer covering the electrodes, and barrier ribs formed on the insulator layer, the sealed part includes a spherical member which regulates any gap formed between the peripheral portions of the front plate and the rear plate,
the dielectric layer is formed as far as location of the spherical member but the insulator layer is formed short of the location of the spherical member in the sealed part on the side of a direction where the display electrodes extend,
the insulator layer is formed as far as the location of the spherical member but the dielectric layer is formed short of the location of the spherical member in the sealed part on the side of a direction where the electrodes extend, and
the spherical member has a diameter larger than a thickness of the dielectric layer and a height of the barrier ribs summed with each other and at most twice as large as the thickness of the dielectric layer and the height of the barrier ribs summed with each other.

2. The plasma display device according to claim 1, wherein
a gap in the sealed part on the side of the direction where the display electrodes extend is larger than a gap in the sealed part on the side of the direction where the electrodes extend.
